(19) United States
(12) Patent Application Publication
(10) Pub. No.: US 2011/0197248 A1
(43) Pub. Date: Aug. 11, 2011

(54) ELECTRONIC DEVICE

(75) Inventor: Hidemi OKA, Hyogo (JP)

(73) Assignee: Panasonic Corporation, Osaka (JP)

(21) Appl. No.: 13/012,812

(22) Filed: Jan. 25, 2011

(30) Foreign Application Priority Data
Jan. 26, 2010 (JP) 2010-013806

(51) Int. Cl. H04N 7/173

(52) U.S. Cl. 725/118

(57) ABSTRACT

An electronic device is provided that includes an input unit and a generation unit. The input unit is configured to receive video data. The generation unit is configured to generate a video stream having a plurality of packets based on the video data received by the input unit. The plurality of packets are arranged along a time axis. The video stream further has a vacant time period situated along the time axis in-between a time assigned to a first packet and a time assigned to a second packet. The length of the vacant time period is configured to accommodate at least one packet. The first and second packets are arranged adjacent to each other along the time axis and are included among the plurality of packets.

### CROSS-REFERENCE TO RELATED APPLICATIONS

This application claims priority under 35 U.S.C. §119 to Japanese Patent Application No. 2010-13806, filed on Jan. 26, 2010. The entire disclosure of Japanese Patent Application No. 2010-13806 is hereby incorporated herein by reference.

### BACKGROUND

1. Technical Field

The technology disclosed herein relates to an electronic device configured to generate a video stream.

2. Background Information

JP H11-103445A discloses a video recording apparatus. This video recording apparatus creates an MPEG2 video stream by supplying a video signal from a camera to an MPEG encoder. A bitmap generation circuit of the video recording apparatus generates bitmap data based on date/time information from a date/time generation circuit. The bitmap data is then converted into a sub video stream by a sub video encoder. The video stream and the sub video stream are multiplexed by a systematized circuit and recorded. Since the date/time information is recorded as a sub video stream, it is possible to switch between displaying and not displaying the date/time information during reproduction.

The video recording apparatus disclosed in JP H11-103445A assumes the use of a DVD as the recording medium. In the DVD-VR standard, it is possible to store sub picture information such as date/time information in a video stream. However, there are also standards, such as SD-Video, that do not permit the storage of sub picture information such as date/time information in a video stream.

### SUMMARY

One object of the technology disclosed herein is to provide an electronic device configured to generate a video stream to which information can be easily added at a later time.

In accordance with one aspect of the technology disclosed herein, an electronic device is provided that includes an input unit and a generation unit. The input unit is configured to receive video data. The generation unit is configured to generate a video stream having a plurality of packets based on the video data received by the input unit. The plurality of packets are arranged along a time axis. The video stream further has a vacant time period situated along the time axis in-between a time assigned to a first packet and a time assigned to a second packet. The length of the vacant time period is configured to accommodate at least one packet. The first and second packets are arranged adjacent to each other along the time axis and are included among the plurality of packets.

These and other objects, features, aspects and advantages of the technology disclosed herein will become apparent to those skilled in the art from the following detailed description, which, taken in conjunction with the annexed drawings, discloses embodiments of the present invention.

### BRIEF DESCRIPTION OF THE DRAWINGS

Referring now to the attached drawings which form a part of this original disclosure:

FIG. 1 is a block diagram showing a configuration of a digital video camera 100;

FIGS. 2A and 2B are schematic diagrams illustrating a difference between an SD card recording format and a DVD recording format;

FIG. 3 is a flowchart showing video data encoding operations;

FIG. 4 is a schematic diagram illustrating times assigned to packets included in an encoded video stream;

FIG. 5 is a flowchart showing operations performed when copying a video stream to a DVD;

FIG. 6 is a schematic diagram illustrating the temporal relationship between encoded GOPs; and

FIG. 7 shows an example of a reproduction screen for a video stream copied to a DVD.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### 1. Embodiment 1

Below is a description of Embodiment 1, in which technology disclosed here has been applied to a digital video camera, with reference to the drawings.

1-1. Overview

A digital video camera 100 of the present embodiment records a video stream on a memory card 240. The digital video camera 100 can copy a video stream recorded on the memory card 240 to a DVD (Digital Versatile Disc) via a DVD burner 290. The digital video camera 100 adds information to the video stream in the case of copying the video stream to the DVD.

The digital video camera 100 can relatively easily add information to the video stream.

1-2. Configuration

1-2-1. Electrical Configuration

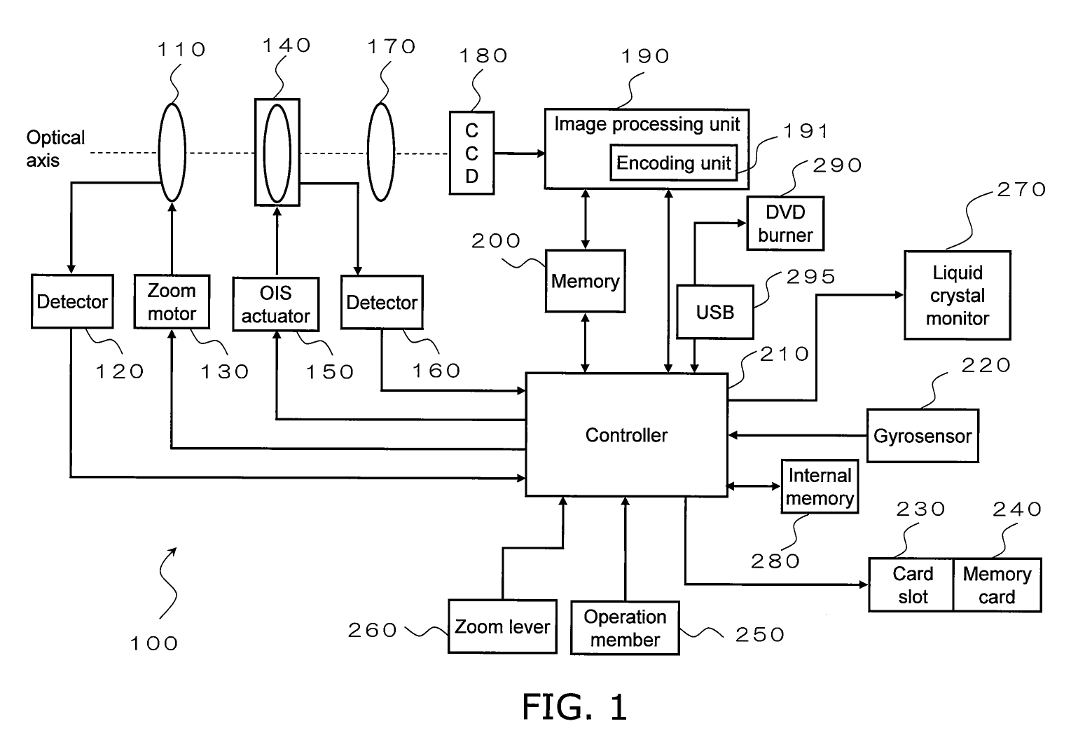

The following describes the electrical configuration of the digital video camera 100 of the present embodiment with reference to FIG. 1. FIG. 1 is a block diagram showing the configuration of the digital video camera 100. A CCD image sensor 180 of the digital video camera 100 captures a subject image formed by an optical system including a zoom lens 110 and the like. Video data generated by the CCD image sensor 180 is subjected to various types of processing by an image processing unit 190, and the resulting video data is stored on the memory card 240 as a video stream. The video stream stored on the memory card 240 can be displayed by a liquid crystal monitor 270. The following is a detailed description of the configuration of the digital video camera 100.

The optical system of the digital video camera 100 includes the zoom lens 110, an OIS (Optical Image Stabilizer) 140, and a focusing lens 170. The zoom lens 110 can magnify or reduce a subject image by moving along the optical axis of the optical system. The focusing lens 170 adjusts the focus of a subject image by moving along the optical axis of the optical system.

The OIS 140 internally includes a correcting lens that can move on a plane perpendicular to the optical axis. The OIS 140 reduces shaking of a subject image by driving the correcting lens in directions such that shaking of the digital video camera 100 is canceled out.

A zoom motor 130 drives the zoom lens 110. The zoom motor 130 may be implemented with a pulse motor, a DC motor, a linear motor, a servo motor, or the like. The zoom motor 130 may be configured so as to drive the zoom lens 110 via a mechanism such as a cam mechanism or a ball screw. A detector 120 detects the position on the optical axis at which the zoom lens 110 is located. With use of a switch such as a brush, the detector 120 outputs a signal related to the position of the zoom lens 110 in accordance with the amount of movement of the zoom lens 110 in the optical axis direction.

An OIS actuator 150 drives the correcting lens inside the OIS 140 on a plane perpendicular to the optical axis. The OIS actuator 150 can be implemented with a planar coil, an ultrasonic motor, or the like. A detector 160 detects the amount of movement of the correcting lens in the OIS 140.

The CCD image sensor 180 generates video data by capturing subject images formed by the optical system including the zoom lens 110 and the like. In other words, the CCD image sensor 180 is a unit that receives an input of video data of a subject from the outside. The CCD image sensor 180 performs various types of operations such as exposure, transfer, and electronic shuttering.

The image processing unit 190 performs various types of processing on the video data generated by the CCD image sensor 180, thus generating video data for display by the liquid crystal monitor 270 and generating a video stream for re-storage (recording) on the memory card 240. For example, the image processing unit 190 subjects the video data generated by the CCD image sensor 180 to various types of processing such as gamma correction, white balance correction, and defect correction. Also, the image processing unit 190 includes an encoding unit 191. The encoding unit 191 generates a video stream by using a compression format complying with the H.264 standard, the MPEG2 standard, or the like to compress the video data generated by the CCD image sensor 180. The image processing unit 190 can be implemented with a DSP, a microcomputer, or the like. In the case where a video stream stored on the memory card 240 is to be copied to a DVD via the DVD burner 290, the encoding unit 191 performs various types of processing such as the generation of menu screen data and the reconstruction of the video stream. The digital video camera 100 and the DVD burner 290 are connected via a USB (Universal Serial Bus) 295. The menu screen data is copied to the DVD together with the reconstructed video stream. A menu screen is a GUI (Graphical User Interface) screen displayed on a display, which is included in or externally attached to a DVD player, when the video stream copied to the DVD is to be reproduced by the DVD player.

A controller 210 is a control unit that performs overall control of the digital video camera 100. The controller 210 can be implemented with a semiconductor element or the like. The controller 210 may be implemented with only hardware, or by a combination of hardware and software. In the present embodiment, the controller 210 is a microcomputer that executes a control program recorded in an internal memory 280.

A memory 200 functions as a work memory for the image processing unit 190 and the controller 210. The memory 200 can be implemented with a DRAM, a ferroelectric memory, or the like.

The liquid crystal monitor 270 can display, for example, images expressed by the video data generated by the CCD image sensor 180 and images expressed by a video stream read out from the memory card 240.

A gyrosensor 220 has an oscillating member such as a piezoelectric element. The gyrosensor 220 obtains angular velocity information by causing the oscillating member to oscillate at a certain frequency and converting the Coriolis force acting on the oscillating member into a voltage. The controller 210 obtains such angular velocity information from the gyrosensor 220. The controller 210 corrects camera shake due to the user by driving the correcting lens inside the OIS 140 in directions such that the shaking indicated by the angular velocity information is canceled out.

The memory card 240 can be inserted into and removed from a card slot 230. The card slot 230 can be mechanically and electrically connected to the memory card 240. The memory card 240 internally includes a flash memory, a ferroelectric memory, or the like. The memory card 240 is a storage medium that stores data such as a video stream generated by the image processing unit 190.

The internal memory 280 can be implemented with a flash memory, a ferroelectric memory, or the like. The internal memory 280 stores, for example, a control program for performing overall control of the digital video camera 100.

An operation member 250 is a member (operation interface) that receives various instructions such as an image capture instruction from the user. A zoom lever 260 is a member (operation interface) that receives a zoom factor change instruction from the user.

The USB 295 is an interface for connecting the digital video camera 100 and an external device such as the DVD burner 290. For example, the USB 295 and the USB of the external device can be connected via a USB cable. The digital video camera 100 can exchange data with the external device via the USB 295.

1-2-2. Recording Format of SD Card and DVD

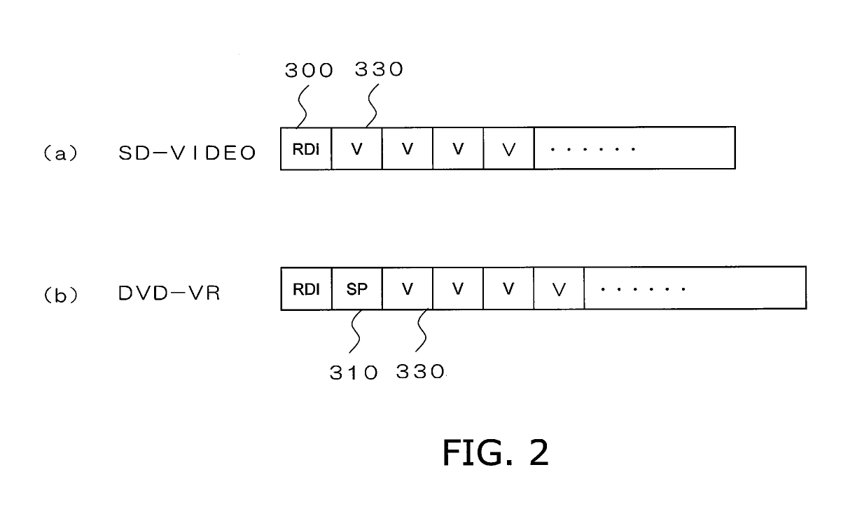

The digital video camera 100 records a video stream on the memory card 240. The digital video camera 100 can copy the video stream recorded on the memory card 240 to a DVD via the DVD burner 290, which is externally attached. Below is a description of a difference between an SD card recording format (recording format of the memory card 240) and a DVD recording format with reference to FIGS. 2A and 2B. FIGS. 2A and 2B are schematic diagrams illustrating a difference between an SD card recording format and a DVD recording format.

The encoding unit 191 uses, for example, the SD-Video standard shown in FIG. 2A when recording video data to an SD card in a compressed format complying with, for example, the MPEG2 standard. A video stream complying with the SD-Video standard or the like is in a format in which an RDI (Real-time Data Information) is multiplexed with V packets and A packets that both follow the RDI. The V packets are compressed video data, and the A packets are compressed audio data. The RDI is a header added as control data to the head of main body data such as video and/or audio. Note that in order to simplify the description of the present embodiment, the example is given in which an RDI 300 is multiplexed with only V packets (compressed video data) following the RDI 300, as shown in FIG. 2A.

On the other hand, when copying a video stream recorded on the memory card 240 to a DVD via the DVD burner 290, the encoding unit 191 uses, for example, the DVD-VR standard shown in FIG. 2B, or the DVD-Video standard (not shown). The DVD-VR standard and the DVD-Video standard employ basically the same packet configuration as the SD-Video standard. However, unlike the SD-Video standard, an SP (Sub Picture) packet 310 can be recorded in the DVD-VR standard and the DVD-Video standard. The SP packet 310 is used by a DVD player or the like to display a sub picture (e.g., subtitles) 310A (see FIG. 7). The sub picture 310A is a picture displayed superimposed on video related to the video stream reproduced by the DVD player or the like. In other words, the SP packet 310 stores sub picture information (e.g., subtitle information). In the digital video camera 100, the SP packet 310 stores information about recording date/time of the video stream. By referencing the SP packet 310 in a video stream that was generated by the digital video camera 100 and stored on the DVD, the DVD player can output the recording date/time of the video data together with video (decoded video) expressed by the video stream (see FIG. 7).

Note that each packet included in the video stream stores an SCR (System Clock Reference) as time information. A decoder (not shown) manages the timing of packet processing by comparing the SCR with an STC (System Time Clock) serving as the reference time in the decoding operation. When generating each packet, the encoding unit 191 uses the data size (Dsize) of one packet and the data transfer rate (prate) to calculate a time interval T (=Dsize/Drate). In other words, the time interval T is the time interval (predicted time interval) necessary for transferring one packet. The encoding unit 191 calculates the SCR of each packet and stores the calculated SCR in that packet. More specifically, the encoding unit 191 adds the calculated time interval T to the SCR of the preceding packet and then updates the SCR of the next packet. Note that in the case there is no packet to be multiplexed, such as the case where the compressed data size of the video stream has decreased, it is possible for an interval longer than the time interval T to elapse before the next compressed data is generated.

As described above, a video stream has a plurality of packets, and each packet belonging to the same video stream has been assigned a time along a predetermined time axis. This time axis is broken up into time intervals T. In other words, all of the packets belonging to the same video stream are arranged on a time axis whose unit is the time interval T.

1-2-3. Correspondence with the Present Invention

The CCD image sensor 180 is an example of an input unit of the present invention. The encoding unit 191 is an example of a generation unit of the present invention. The memory card 240 is an example of a storage unit of the present invention. The USB 295 serving as the interface for connection with the DVD burner 290 is an example of a transfer unit of the present invention.

1-3. Operations

1-3-1. Encoding Operations

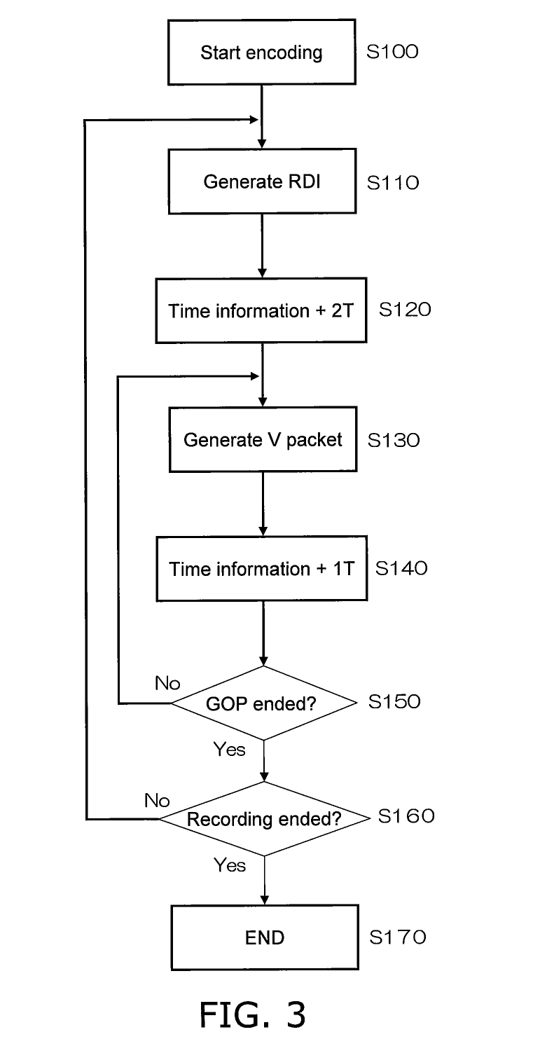

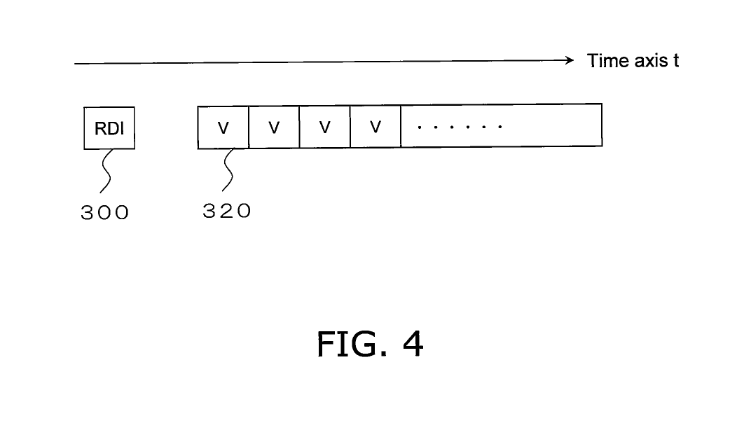

Next is a description of video data encoding operations in the digital video camera 100 with reference to FIGS. 3 and 4. FIG. 3 is a flowchart showing video data encoding operations performed in the digital video camera 100. FIG. 4 is a schematic diagram illustrating an encoded video stream.

When the user has instructed the recording of a video stream to start by operating the digital video camera 100, the encoding unit 191 starts video data encoding (S100). The encoding unit 191 thereafter generates a video stream based on video data that the CCD image sensor 180 has received. Here, the encoding unit 191 determines the SCR of the head packet of the video stream that is to be generated (S100). After encoding the video data received by the CCD image sensor 180, the encoding unit 191 stores the encoded video data in the memory 200 (S100). The encoding unit 191 starts multiplex processing once a predetermined amount of video data has been accumulated in the memory 200. Upon starting multiplex processing, the encoding unit 191 generates the RDI 300 and multiplexes the RDI 300 at the head of a GOP (Group Of Pictures) (S110). Here, the encoding unit 191 stores the SCR determined in step S100 in the RDI 300 (S110). The controller 210 then stores the created RDI 300 on the memory card 240 (S110).

After multiplexing the RDI 300, the encoding unit 191 adds 2 T (time interval T×2) to the SCR determined in step S100 (S120). After adding 2 T to the SCR determined in step S100, the encoding unit 191 generates a V packet (S130). Then encoding unit 191 stores the SCR calculated in step S120 in the generated V packet (S130). Thereafter, the controller 210 stores the created V packet on the memory card 240 (S130).

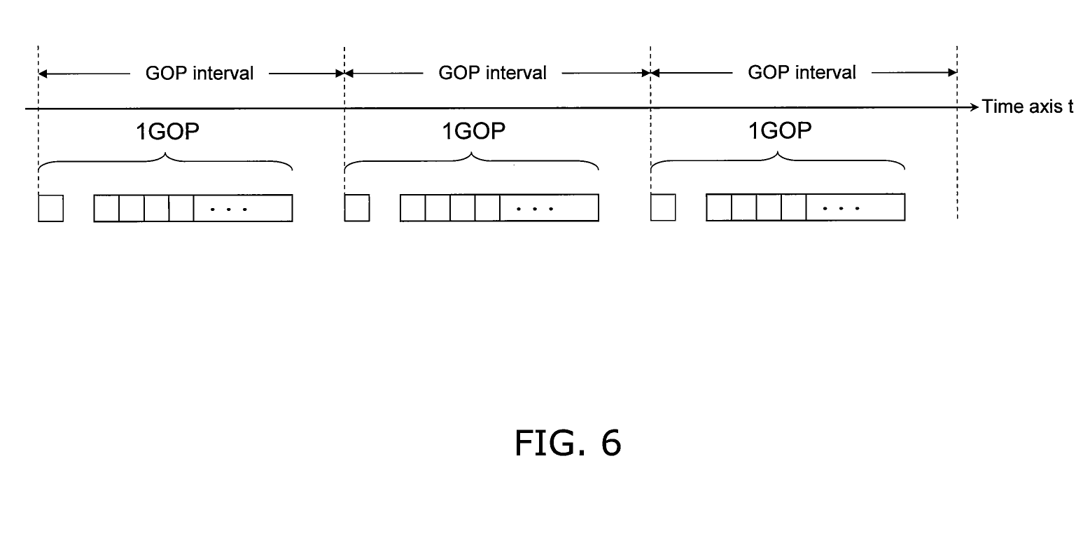

After generating the V packet, the encoding unit 191 calculates an SCR by adding T to the SCR of the most recently generated V packet (S140). After calculating the SCR by adding T to the SCR of the most recently generated V packet, the encoding unit 191 determines whether the generation of packets up to the end of the GOP has ended (S150). If the encoding unit 191 has determined that the generation of packets up to the end of the GOP has not ended, the procedure returns to step S130. Note that when a V packet is generated in step S130 immediately after step S150, the SCR that was calculated in step S140 immediately before the step S150 is stored in that V packet. On the other hand, if the encoding unit 191 has determined that the generation of packets up to the end of the GOP has ended, the encoding unit 191 determines whether the controller 210 has issued an instruction to stop the encoding processing (S160). The controller 210 issues an encoding processing stop instruction to the encoding unit 191 in accordance with an instruction input by the user via the operation member 250 to stop video stream recording. If the encoding unit 191 has determined that the stop instruction has been received, the encoding unit 191 stops the encoding processing (S170). On the other hand, if the encoding unit 191 has determined that the stop instruction has not been received, the procedure returns to step S110, and the encoding unit 191 generates the next RDI 300 such that the SCR thereof is time information in accordance with the GOP interval (S110). In other words, the encoding unit 191 sets the SCR of the RDI 300 of the GOP to be newly generated, as time information that is put forward by one GOP interval after the SCR of the RDI 300 of the most recently generated GOP (see FIG. 6). The controller 210 then stores the new RDI 300 on the memory card 240 (S110).

According to this processing, each of the GOPs of the video stream generated by the encoding unit 191 has the packet configuration shown in FIG. 4, in which the packets included in the GOP are arranged on a time axis according the SCR values thereof. In other words, the video stream generated by this processing is a video stream in which each GOP reliably includes a gap with the length corresponding to one packet (the time interval T) between the RDI 300 and a V packet 330. Note that the interval between the time assigned to the RDI 300 and the time assigned to the V packet 330 is 2 T. The V packet 330 is, among the series of V packets included in a GOP, the V packet at the head with respect to the time axis. Note that FIG. 6 shows how a plurality of GOPs included in a video stream are arranged on a time axis.

In this way, when encoding video data, the digital video camera 100 of the present embodiment creates a one-packet gap (a gap whose length is one packet length) between the RDI 300 and the packet generated immediately after the RDI 300. In other words, in each of the GOPs included in the video stream, there exists a gap (a vacant time period) equal to the time interval T between the time assigned to the RDI 300 (an example of a first packet) and the time assigned to the V packet 330 (an example of a second packet). The RDI 300 and the V packet 330 are included among the packets belonging to the GOP. The RDI 300 and the V packet 330 are adjacent to each other on the time axis. As will be described later, the SP packet 310, which is sub picture information, can at a later time be inserted into the gap equal to the time interval T between the RDI 300 and the V packet adjacent to the RDI 300 on the time axis. The following is a specific description of a reason for employing such a configuration.

In the SD-Video standard, the SP packet 310 cannot be recorded in a GOP. For this reason, the digital video camera 100 does not record sub picture information (e.g., subtitle information) when recording a video stream on the memory card 240. When copying a video stream recorded on the memory card 240 to a DVD via the DVD burner 290, the digital video camera 100 needs to insert the SP packet 310 into the video stream in order to create a video stream in which the sub picture 310A can be displayed.

Here, assume that the time difference between the SCRs of the head RDI 300 and the V packet 330 is the time interval T in a video stream to be recorded on the memory card 240. As can be seen in FIG. 2B, in the case of copying the video stream from the memory card 240 to the DVD, when the encoding unit 191 attempts to insert the SP packet 310 into the video stream, the time difference between the RDI 300 and the SP packet 310 needs to be T or more, and the time difference between the SP packet 310 and the V packet 330 needs to be T or more. In order to achieve this, the encoding unit 191 needs to add an extra value greater than or equal to T to the SCR of the V packet 330 in the video stream. In other words, the encoding unit 191 needs to change the SCR of the V packet 330 such that the time difference between the RDI 300 and the V packet 330 is 2 T or more. The encoding unit 191 furthermore needs to change the SCRs of all of the V packets following the V packet 330.

Accordingly, when encoding video data, the digital video camera 100 of the present embodiment creates a one-packet gap between the RDI 300 and the V packet generated immediately after the RDI 300. This causes the time difference between the RDI 300 and the V packet 330 to be 2 T. As a result, when copying a video stream recorded on the memory card 240 to a DVD, free time (vacant time period) equal to the time interval T for the addition of the SP packet 310 is already reserved on the time axis on which the packets included in the video stream are arranged. This eliminates the need to change the SCRs of the V packets in the video stream when copying it from the memory card 240 to the DVD.

1-3-2. Operations for Conversion from SD-Video to DVD-VR

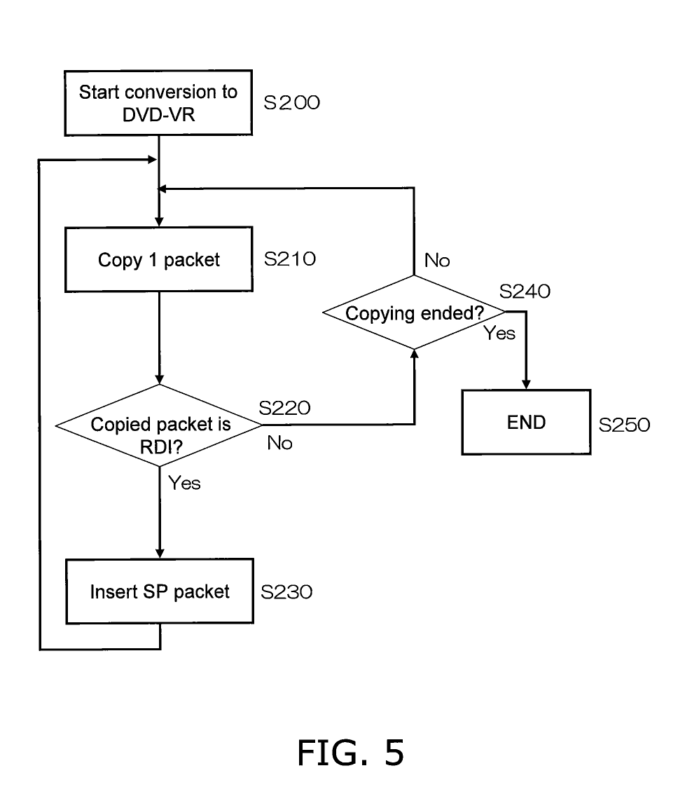

Next is a description of processing for adding the SP packet 310 to a video stream recorded in compliance with the SD-Video standard as shown in FIG. 4 and copying the resulting video stream to a DVD, with reference to FIG. 5. FIG. 5 is a flowchart showing operations for adding an SP packet to a video stream complying with the SD-Video standard and copying the resulting video stream to a DVD.

Upon receiving an instruction to copy a video stream to a DVD from the user via the operation member 250, the controller 210 starts copying a video stream recorded on the memory card 240 to a DVD (S200). In other words, in step S200, the encoding unit 191 starts processing for converting a video stream complying with the SD-Video standard that is recorded on the memory card 240 into a video stream complying with the DVD-VR standard. When the copying of the video stream to the DVD has started, the encoding unit 191 selects one of the packets included in the video stream (S210). Next, the controller 210 copies the packet selected by the encoding unit 191 to the DVD (S210). At this time, the USB 295 transfers the packet selected by the encoding unit 191 to the DVD.

When one packet has been copied, the encoding unit 191 determines whether the copied packet is the RDI 300 (S220).

Upon determining that the packet is the RDI 300, the encoding unit 191 generates the SP packet 310 and inserts the SP packet 310 into the video stream being copied (S230). At this time, the USB 295 transfers the SP packet 310 generated by the encoding unit 191 to the DVD. The SCR of the generated SP packet 310 is time information that is put forward by one time interval T after the SCR of the RDI 300 copied in the most recent step S210.

The SP packet 310 includes sub picture information to be added to the video stream that is currently to be copied to the DVD. In the present embodiment, the sub picture 310A indicates the recording date/time of the video stream, as shown in FIG. 7. In the present embodiment, one GOP is video data for 0.5 seconds of playback time, and includes 15 frames. While 15 frames-worth of video is consecutively played back in 0.5 seconds, the sub picture 310A is displayed superimposed on the 15 frames-worth of video at a predetermined position on the display displaying the 15 frames-worth of video, based on the sub picture information. In the present embodiment, the recording date/time information multiplexed with the video stream is information in units of one second. Accordingly, two consecutive GOPs that make up one second-worth of video data have the same picture information stored therein as sub picture information. In the present embodiment, the video stream is stored on the memory card 240 in a file format. Furthermore, the recording start date/time of the video stream is stored in the header of the video stream file. Accordingly, the encoding unit 191 determines the recording date/time information that is to be the sub picture information by referencing the recording start date/time in the header of the video stream file and the time indicated by the SCR of a predetermined packet (e.g., the RDI 300) in a GOP.

When the insertion of the SP packet 310 has ended, the encoding unit 191 returns to step S210 and selects another packet. The packet selected by the encoding unit 191 is then copied to the DVD.

On the other hand, upon determining in step S220 that the copied packet is not the RDI 300, the encoding unit 191 determines whether the copying of all of the packets that are to be copied has ended (S240). If it has been determined that the copying of all of the packets has ended, the controller 210 ends the copying of the video stream to the DVD. On the other hand, if it has been determined that the copying of all of the packets has not ended, the encoding unit 191 returns to step S210 and selects another packet. The packet selected by the encoding unit 191 is then copied to the DVD.

According to the above processing, the digital video camera 100 can copy a video stream recorded on the memory card 240 to a DVD after having easily inserted the SP packet 310 into the video stream.

In the present embodiment, a gap equivalent to one packet length is provided in advance between the RDI 300 and the V packet 330. As a result, the SP packet 310 can be easily inserted when copying the video stream recorded on the memory card 240 to the DVD.

### 2. Features

In the above-described embodiment, the digital camera 100 includes the CCD image sensor 180 and the encoding unit 191. The encoding unit 191 generates a video stream by compressing video data captured by the CCD image sensor 180 in units of packets. In the generation of the video stream, the encoding unit 191 reserves a free region for the storage of sub picture information to be added at a later time. Note that the free region is a virtual region provided on a time axis along which the packets included in the video stream are arranged.

Also, the encoding unit 191 reserves the free region for the storage of sub picture information to be added at a later time, for each GOP. Moreover, the encoding unit 191 reserves the free region for the storage of sub picture information to be added at a later time, between one real data piece and another real data piece in the GOP.

The digital camera 100 furthermore includes the memory card 240 and the USB 295. The memory card 240 stores the video stream generated by the encoding unit 191. The USB 295 transfers the video stream stored on the memory card 240 to a DVD. The video stream transferred to the DVD by the USB 295 is a video stream obtained by adding sub picture information to the free regions in the video stream stored on the memory card 240.

### 3. Other embodiments

Although Embodiment 1 of the present invention is described above, the present invention is not limited to this. The following is a description of other embodiments of the present invention.

(3-1)

The optical system and driving system of the digital camera 100 according to the above-described embodiment are not limited to those shown in FIG. 1. For example, although an optical system having a three-group configuration is shown as an example in FIG. 1, another type of group configuration may be used as the lens configuration. Also, each lens may have only one lens or a lens group made up of a plurality of lenses.

(3-2)

Although the CCD image sensor 180 is described as an example of the imaging unit in Embodiment 1, the present invention is not limited to this. For example, the imaging unit may be a CMOS image sensor or an NMOS image sensor.

(3-3)

Although recording date/time information is described as an example of the sub picture information in Embodiment 1, the sub picture information is not necessarily limited to this. For example, the sub picture information may be information indicating the recording mode at the time when the video stream was recorded. Recording modes are modes having different compression rates, such as SP and LP. Also, a configuration is possible in which the user can set, via the operation member 250, the type of sub picture information to be added to a video stream that is to be copied to a DVD.

(3-4)

Although the example in which sub picture information is added to a video stream to be copied to a DVD is described in Embodiment 1, the present invention is not necessarily limited to this. The present invention is also applicable to, for example, the case where any type of information is added to a video stream at a later time.

(3-5)

In the processing of step S140 shown in FIG. 3 in Embodiment 1, time interval T is always added to the time information each time one packet is processed. In other words, a gap on the time axis, into which the SP packet 310 can be added at a later time, is reliably reserved only between the RDI 300 and the V packet 330 in one GOP. The present invention, however, is not necessarily limited to this example. For example, in a GOP, a gap on the time axis may be reliably reserved not only between the RDI 300 and the V packet 330, but also between V packets. In particular, a gap on the time axis may be reserved for each packet, for a predetermined number of packets greater than or equal to two, or at a predetermined position in the packet arrangement. Also, the length of the gap is not limited to the time interval T, but rather can be an arbitrary length that enables the addition of the SP packet 310 at a later time, that is to say, an arbitrary length of time greater than or equal to T.

(3-6)

Although the example of multiplexing only the RDI 300 and V packets as the video stream is described in Embodiment 1, the present invention is not necessarily limited to this example. The RDI 300, V packets, and A packets may of course be multiplexed in the video stream, or a combination of other types of packets may of course be multiplexed.

(3-7)

Although the example of copying a video stream to a DVD via the externally-attached DVD burner 290 is described in Embodiment 1, the present invention is not necessarily limited to this example. The present invention is also applicable to, for example, the case of copying a video stream to a BD (Blu-ray Disc) via a BD burner.

(3-8)

Although the example of applying the present invention to a digital video camera is described in Embodiment 1, the present invention is not necessarily limited to this example. The present invention is also applicable to an electronic device such as a digital still camera or a mobile phone.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of an electronic device. Accordingly, these terms, as utilized to describe the present invention should be interpreted relative to an electronic device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1.-7. (canceled)

8. An electronic device comprising:
an input unit configured to receive video data; and
a generation unit configured to generate a video stream having a plurality of packets based on the video data received by the input unit, the plurality of packets being arranged along a time axis, the video stream further having a vacant time period situated along the time axis in-between a time assigned to a first packet and a time assigned to a second packet, the length of the vacant time period being configured to accommodate at least one packet, the first and second packets being arranged adjacent to each other along the time axis and included among the plurality of packets.

9. The electronic device according to claim 8, wherein
the generation unit is further configured to generate the video stream such that the vacant time period exists in each GOP.

10. The electronic device according to claim 8, wherein
the at least one packet is information regarding a picture to be superimposed and displayed on a video image based on the video stream.

11. The electronic device according to claim 8, further comprising:
a storage unit configured to store the video stream generated by the generation unit; and
a transfer unit configured to transfer the video stream stored in the storage unit to an external device,
wherein the at least one packet is added to the vacant time period of the video stream stored in the storage unit, and
the transfer unit is configured to transfer the video stream with the added at least one packet to the external device.

12. The electronic device according to claim 9, wherein
the at least one packet is information regarding a picture to be superimposed and displayed on a video image based on the video stream.

13. The electronic device according to claim 9, further comprising:
a storage unit configured to store the video stream generated by the generation unit; and
a transfer unit configured to transfer the video stream stored in the storage unit to an external device,
wherein the at least one packet is added to the vacant time period of the video stream stored in the storage unit, and
the transfer unit is configured to transfer the video stream with the added at least one packet to the external device.

14. The electronic device according to claim 10, further comprising:
a storage unit configured to store the video stream generated by the generation unit; and
a transfer unit configured to transfer the video stream stored in the storage unit to an external device,
wherein the at least one packet is added to the vacant time period of the video stream stored in the storage unit, and
the transfer unit is configured to transfer the video stream with the added at least one packet to the external device.
